(19) United States
(12) Patent Application Publication
(10) Pub. No.: US 2015/0255863 A1
(43) Pub. Date: Sep. 10, 2015

(54) ANTENNA DEVICE

(71) Applicant: NEC CORPORATION, Tokyo (JP)

(72) Inventor: Takahide Yoshida, Tokyo (JP)

(73) Assignee: NEC CORPORATION, Tokyo (JP)

(21) Appl. No.: 14/424,813

(22) PCT Filed: Jul. 19, 2013
(86) PCT No.: PCT/JP2013/070261

§ 371 Date: Feb. 27, 2015

(30) Foreign Application Priority Data
Sep. 13, 2012 (JP) 2012-201884

(51) Int. Cl. H01Q 1/52; H01Q 21/28

(52) U.S. Cl. CPC H01Q 1/521; H01Q 21/28

(57) ABSTRACT

An antenna device includes: a plurality of antenna elements of at least two or more; transmission lines connected to said antenna elements, respectively; a filter circuit connected between each of said transmission lines; a matching circuit connected, in said transmission lines, with an end opposite to said plurality of antenna elements; and an antenna port connected with said matching circuit. Isolation between all antenna ports is achieved about said plurality of antenna elements having a plurality of frequency bands in common with each other by choosing an electrical length of said transmission lines and a design condition of said filter circuit.

### TECHNICAL FIELD

The present invention relates to an antenna device in a radio communication apparatus using a MIMO system.

### BACKGROUND ART

In recent years, a plurality of antenna elements having identical frequencies have begun to be mounted in equipment like a mobile terminal along with the popularization of a MIMO (Multiple-Input Multiple-Output) system. However, when a plurality of antenna elements having identical frequencies are adjacent to each other in a terminal having a small mounting area, mutual coupling is caused, resulting in decline of an antenna radiation efficiency and degeneration of a space correlation coefficient. Thus, it becomes a factor which deteriorates the MIMO communication performance.

As a solution for it, in an antenna structural object indicated in FIG. 10B of patent literature 1, for example, a connection device is provided between neighboring antenna elements, and the length of the connection device and its installation position are adjusted. There is being adopted a structure which can, by giving an appropriate susceptance value by the above, suppress isolation between antenna ports.

### CITATION LIST

### Patent Literature

[PTL n] Patent literature 1: Japanese Patent Publication No.

### SUMMARY OF INVENTION

### Technical Problem

However, there is the following problem with the antenna structure disclosed in patent document 1. That is, isolation between antenna ports can be realized only in a specific frequency band because, in a case of a plurality of antenna elements having a plurality of frequency bands in common with each other, a connection device has only a monotonous frequency operation as an inductor only by inserting a connection device between each antenna element. Rather, there is a high possibility that mutual coupling between antenna ports becomes stronger in the other frequency bands, and thus it will be a cause to deteriorate the MIMO communication performance.

The present invention tries to provide an antenna device which compensates, for a plurality of antenna elements having a plurality of frequency bands in common with each other, isolation between antenna ports in each of the frequency bands.

### Solution to Problem

An antenna device in the present invention includes: at least two antenna elements; transmission lines connected to each of said antenna elements, respectively; a filter circuit connected between each of said transmission lines; a matching circuit connected to an end part of each of said transmission lines; and each of said antenna elements having a plurality of frequency bands in common with each other. Said filter circuit has a passband in a specific frequency band of said antenna element. Said filter circuit is formed using a lumped constant circuit or a distributed constant circuit, and mutual coupling between antennas is suppressed by making a total of a phase difference between said antenna elements and an electrical length of said transmission lines be plus or minus 90 degrees, and by giving a non-coupling value to enable susceptance of said filter circuit to be decided by a coupling coefficient between antennas.

### Advantageous Effects of Invention

According to the present invention, there can be provided an antenna device in which, about a plurality of antenna elements having a plurality of frequency bands in common with each other, isolation can be achieved between all antenna ports in the plurality of frequency bands.

### BRIEF DESCRIPTION OF DRAWINGS

FIG. 1 is a circuit diagram of an antenna device according to a first exemplary embodiment of the present invention.

FIG. 2 is a circuit diagram in which a matching circuit is added to an end of an antenna of the first exemplary embodiment of FIG. 1.

FIG. 3 is a circuit diagram illustrating an example of a low-pass filter which can be applied to the first exemplary embodiment of the present invention.

FIG. 4 is a diagram illustrating an antenna device in which the first exemplary embodiment of the present invention is embodied.

FIG. 5 is a diagram describing details of the filter circuit and the matching circuit in FIG. 4.

FIG. 6 is a diagram showing frequency characteristics of an S parameter of the antenna device of FIG. 4.

FIG. 7 is a diagram showing frequency characteristics of a correlation coefficient of the antenna device of FIG. 4.

FIG. 8 is a circuit diagram of an antenna device according to a second exemplary embodiment of the present invention.

FIG. 9 is a circuit diagram showing an antenna device according to a third exemplary embodiment of the present invention.

FIG. 10 is a circuit diagram showing an antenna device according to a fourth exemplary embodiment of the present invention.

### DESCRIPTION OF EMBODIMENTS

### Structure

The first exemplary embodiment of an antenna device according to the present invention will be described in detail with reference to a drawing.

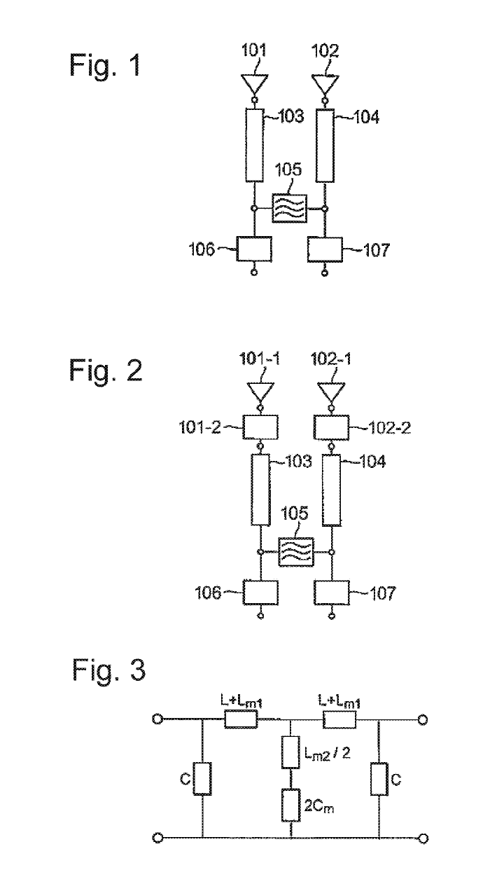

FIG. 1 is a circuit diagram illustrating the basic structure of an antenna device according to the first exemplary embodiment of the present invention.

In FIG. 1, the numbers 101 and 102 indicate a first and a second antenna element, 103 and 104 a first and a second transmission line, 105 a filter circuit, and 106 and 107 a first and a second matching circuit. The first matching circuit 106 and the second matching circuit 107 perform impedance matching when taking a look toward the side of the first antenna element 101 and the second antenna element 102. The first antenna element 101 and the second antenna element 102 may be of different structures, different kinds and different arrangements in so far as they have same frequency bands.

The first transmission line 103 and the second transmission line 104 may be of any kind, any length and any shape in so far as they satisfy the condition of Formula (1) described later. As the filter circuit 105, a low-pass filter, a high-pass filter, a band-pass filter and a band reject filter, for example, can be used, and a filter using lumped constant circuit or a distributed constant circuit can be used. By using a filter circuit in the circuit 105, a complicated alteration can be given to the frequency characteristics of susceptance for determining a non-coupling value that is important when isolation between antenna ports is realized, and thus isolation between antenna ports is made easy in multiple bands.

FIG. 2 is a circuit diagram of an antenna device made by adding, to the antenna device illustrated in FIG. 1, matching circuits 101-2 and 102-2 near antenna elements 101-1 and 102-1, respectively.

Although the matching circuit 101-2 and the matching circuit 102-2 in FIG. 2 are not needed necessarily in designing, they are introduced expediently here because they can be mounted in order to make designing of an antenna device easy.

The filter circuit 105 in FIG. 1 or FIG. 2 can be formed by a low-pass filter circuit in which an inductors (L+Lₘ₁) and Lₘ₂/2 and capacitors C and 2Cₘ, for example, are put together like FIG. 3. Here, L is the inductance of an inductor forming a low-pass filter, C and Cₘ are the capacitance of capacitors forming the low-pass filter, and Lₘ₁ and Lₘ₂ are the inductance of inductors forming the low-pass filter.

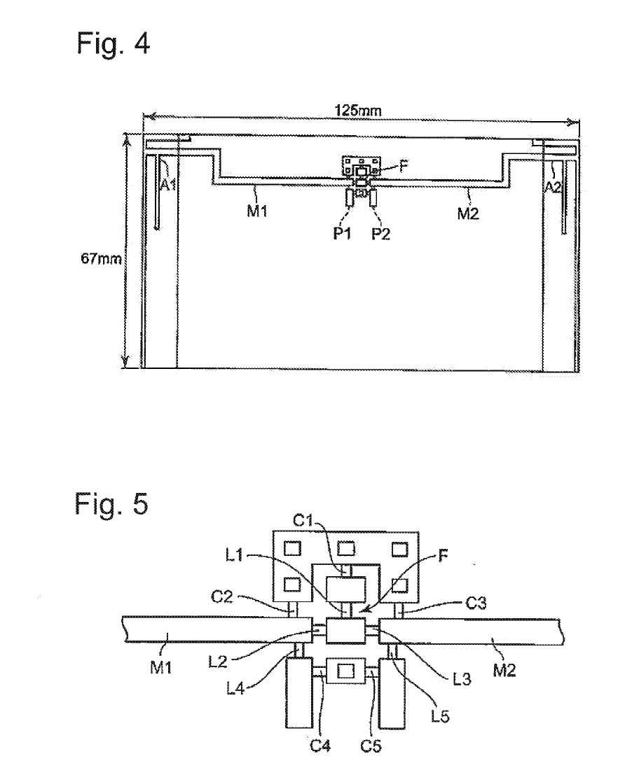

FIG. 4 is a diagram illustrating an antenna device in which the first exemplary embodiment of the present invention is realized specifically by a substrate. Here, an inverted F antenna is used as an antenna element, microstrip lines M1 and M2 are wired from antenna elements A1 and A2 in the both sides of a substrate, respectively, and are connected to a filter circuit F and a matching circuit arranged in the center of the substrate. The matching circuit 101-2 and the matching circuit 102-2 in FIG. 2 correspond to a short line in an inverted F antenna. Both the two antenna elements A1 and A2 are designed to have frequency bands in 850 MHz band and 2.1 GHz band.

FIG. 5 is a diagram describing details of the filter circuit F and the matching circuit in the antenna device of FIG. 4. L1-L3 and C1-C3 are the lumped constants making up the filter circuit F, and L4, L5, C4 and C5 represent the lumped constants making up the matching circuit.

Specifically, L1-L3 are the inductance of inductors forming a low-pass filter, L4 and L5 are the inductance of inductors forming the matching circuit, and C1-C3 are the capacitance of capacitors forming the low-pass filter and C4 and C5 are the capacitance of capacitors forming the matching circuit. Here, L1=3.8 nH, L2=4.5 nH, L3=4.5 nH, L4=1 nH, L5=1 nH, C1=2.7 pF, C2=2.05 pF, C3=2.05 pF, C4=2 pF and C5=2 pF.

The filter circuit F is designed to have a stop band in 2.1 GHz band and a path band in 850 MHz band.

In order to realize isolation between antenna ports, electrical length θ1 of the microstrip line M1 that is the first transmission line, electrical length θ2 of the microstrip line M2 that is the second transmission line and a lumped constant value of the filter circuit F are designed so that the following conditional expression (1) may be filled in a plurality of desired frequency bands.

$$B = \frac{\pm 2 α}{1 + {α}^{2}} {Y}_{0} \\ {θ}_{1} + {θ}_{1} + φ = \pm \frac{π}{2} \qquad ( 1 )$$

In the above Formula (1), B represents the susceptance of the filter circuit F, and α and θ represent a coupling coefficient and a phase difference, respectively, between the antenna elements A1 and A2 in a case where only the antenna elements A1 and A2 are mounted. Y₀ is a characteristic admittance.

Designing is performed in a plurality of desired frequency bands so that the total of a phase difference between the antenna elements A1 and A2 and the electrical lengths of the micro strip lines M1 and M2 may be made to be plus or minus 90 degrees (π/2), and the susceptance of the filter circuit F to be the non-coupling value B decided by coupling coefficient α between the antenna elements A1 and A2. By this, mutual coupling between the antenna elements A1 and A2 can be suppressed. Here, an event that the susceptance of the filter circuit F becomes a non-coupling value B in the above Formula (1) indicates a situation that S parameter S21 (or, S12) mentioned later becomes minimal.

Therefore, a condition of the above Formula (1) can be found by taking lumped constants in the filter circuit F as a parameter. Specifically, L1, L2, L3 and C1 can be employed as a parameter.

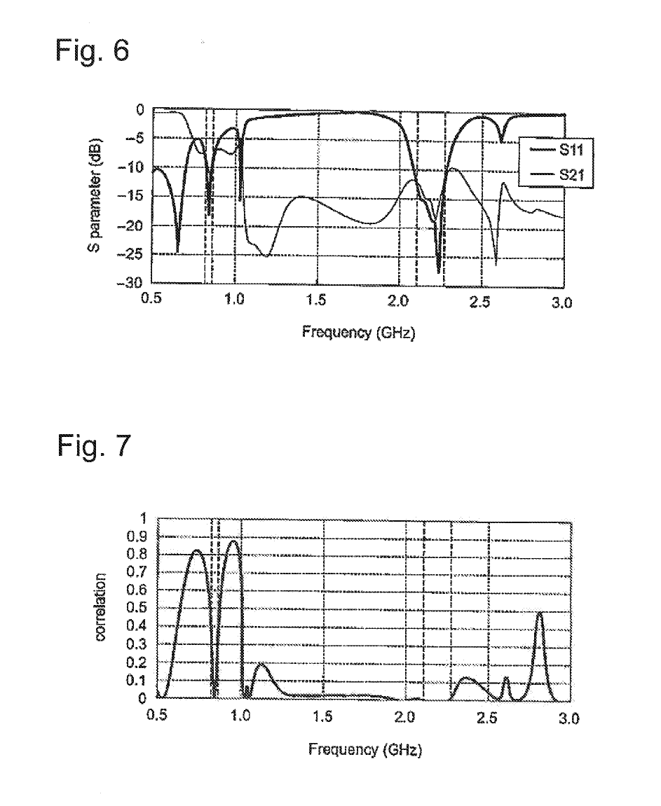

FIG. 6 is a diagram illustrating frequency characteristics of S parameters of the substrate in FIG. 4. Here, S parameters when making a power feeding part P1 and a power feeding part P2 shown in FIG. 4 be antenna ports are indicated. Although only S11 and S21 are shown here, S22 and S12 also indicate the same result as S11 and S21, respectively. This is because S22 =S11 and S12=S21 are ensured from the symmetry and reversibility of the antenna substrate. Because both S11 and S21 indicate a dip in 850 MHz and 2.1 GHz which are the frequency bands of the antennas, it is found that, in the two bands, isolation between the antenna ports are achieved as well as resonance characteristics of the antennas.

FIG. 7 is a correlation coefficient between the ports calculated from the S parameters of FIG. 6. Correlation coefficient ρₑ can be expressed by the following Formula (2) when two antenna structures have a symmetrical structure.

$${ρ}_{e} = \frac{{\vert {S}_{11}^{*} {S}_{12} + {S}_{21}^{*} {S}_{22} \vert}^{2}}{( 1 - ( {\vert {S}_{11} \vert}^{2} + {\vert {S}_{21} \vert}^{2} ) ) ( 1 - ( {\vert {S}_{22} \vert}^{2} + {\vert {S}_{12} \vert}^{2} ) )} \qquad ( 2 )$$

The correlation coefficient ρe is found out to be approximately zero at just 850 MHz and at 2.1 GHz, and this sufficiently meets a low correlation required to obtain good characteristics in MIMO communication.

### Other Exemplary Embodiments

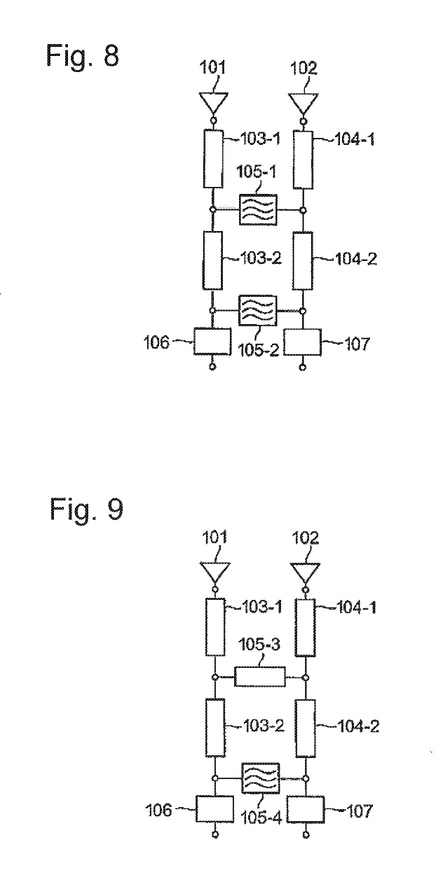

By mounting filter circuits in a multiple-stage manner in the first exemplary embodiment mentioned above, isolation can be realized even in more multiple bands. A structure for this is shown in FIG. 8 as the second exemplary embodiment.

In FIG. 8, this antenna device is made to be a multiple-stage structure in which a filter circuit 105-1 is connected between a transmission line 103-1 connected with an antenna element 101 and a transmission line 104-1 connected with an antenna element 102, and a filter circuit 105-2 is connected between a transmission line 103-2 connected with the transmission line 103-1 and a transmission line 104-2 connected with the transmission line 104-1. Here, the numbers 106 and 107 indicate matching circuits.

Although, in the second exemplary embodiment, the filter circuits 105-1 and 105-2 of two stages are inserted between the transmission lines as a specific example, there is no problem to mount filter circuits more than that. By inserting filter circuits in a multiple-stage manner, it becomes possible to realize isolation between ports in a plurality of bands.

The present invention becomes capable of coping with a plurality of bands also by using, as the third exemplary embodiment, a filter circuit 105-4 and a susceptance element 105-3 including inductors or capacitors for isolation between ports in a combined manner as shown in FIG. 9.

In FIG. 9, an antenna device according to the third exemplary embodiment is made to be of a structure that the susceptance element 105-3 is connected between the transmission line 103-1 connected with the antenna element 101 and the transmission line 104-1 connected with the antenna element 102 and the filter circuit 105-4 is connected between the transmission line 103-2 connected with the transmission line 103-1 and the transmission line 104-2 connected with the transmission line 104-1.

Although, in the third exemplary embodiment, a structure in which one filter circuit and one susceptance element are employed has been indicated as a specific example, these may be inserted in a multiple-stage manner. Here, the numbers 106 and 107 are matching circuits.

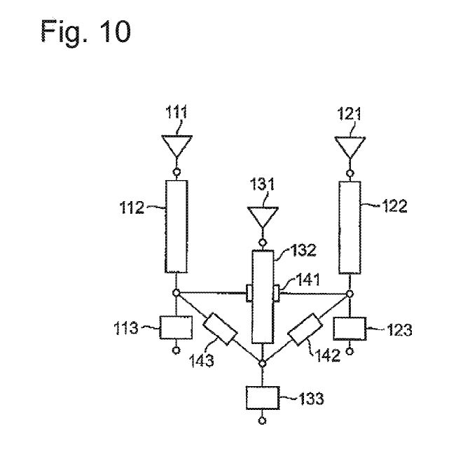

The present invention is also applicable in a case of three antenna elements or more. A structure for that is shown in FIG. 10 as the fourth exemplary embodiment.

In FIG. 10, transmission lines 112, 122 and 132 are connected to antenna elements 111, 121 and 131, respectively, and a filter circuit 141 is connected between the transmission line 112 and the transmission line 122, a filter circuit 142 is connected between the transmission line 122 and the transmission line 132, and a filter circuit 143 is connected between the transmission line 112 and the transmission line 132 A matching circuit 113 is connected to an end of the transmission line 112, a matching circuit 123 to an end of the transmission line 122 and a matching circuit 133 to an end of the transmission line 132, respectively. Although a case of three antenna elements is indicated for simplicity here, it is also applicable in the same way in a case of the number of antenna elements more than that.

Although the present invention has been described with reference to a plurality of exemplary embodiments above, the present invention is not limited to the above-mentioned exemplary embodiments. Various changes which a person skilled in the art can understand can be made to the compositions and details of the present invention within the spirit and the scope of the present invention described in the claims.

### INDUSTRIAL APPLICABILITY

The present invention is applicable in wireless radio equipment using a plurality of antenna elements. It can be loaded into equipment such as a base station and terminals for mobile communication or wireless LAN (Local Area Network) routers.

This application claims priority based on Japanese application Japanese Patent Application No. 2012-201884 filed on Sep. 13, 2012, the disclosure of which is incorporated herein in its entirety.

### Reference Signs List

101, 102, 101-1, 102-1, 111, 121 and 131 Antenna element
103, 104, 103-1, 103-2, 104-1, 104-2, 112, 122 and 132 Transmission line
101-2, 102-2, 106, 107, 113, 123 and 133 Matching circuit
105, 105-1, 105-2, 105-4, 141, 142, 143 Filter circuit
105-3 Susceptance element

1. An antenna device, comprising: a plurality of antenna elements of at least two or more; transmission lines connected to each of said antenna elements, respectively; a filter circuit connected between each of said transmission lines; a matching circuit connected to an end part of each of said transmission lines; each of said antenna elements having a plurality of frequency bands in common with each other; said filter circuit having a passband in a specific frequency band of said antenna elements; said filter circuit being formed using one of a lumped constant circuit and a distributed constant circuit; and said filter circuit suppressing mutual coupling between each of said antenna elements over a plurality of frequency bands.

2. The antenna device according to claim 1, wherein mutual coupling between antennas is suppressed by making, over a plurality of frequencies, a total of a phase difference between said antenna elements and an electrical length of said transmission lines be plus or minus 90 degrees, and by giving a non-coupling value to enable susceptance of said filter circuit to be decided by a coupling coefficient between antennas.

3. The antenna device according to claim 1, wherein mutual coupling between antenna elements is suppressed in a plurality of frequency bands by inserting a plurality of pieces of said filter circuit between transmission lines.

4. The antenna device according to claim 1, wherein mutual coupling between antenna elements is suppressed in a plurality of frequency bands by inserting one or more stages of susceptance elements along with said filter circuit.

5. The antenna device according to claim 1, wherein said matching circuit adjusts impedance of an antenna element side.
